(19) United States
(12) Patent Application Publication
(10) Pub. No.: US 2001/0006017 A1
(43) Pub. Date: Jul. 5, 2001

(54) Saw blade for electric power saw

(76) Inventors: Yoshio Osada, Hitachinaka-shi (JP); Tadao Matsuda, Kobe-shi (JP)

Correspondence Address: BIRCH, STEWART, KOLASCH & BIRCH, LLP, P.O. Box 747, Falls Church, VA, 22040-0747, US

(21) Appl. No.: 09/749,699

(22) Filed: Dec. 28, 2000

(30) Foreign Application Priority Data
Dec. 28, 1999 (JP) 11-373399

(51) Int. Cl. B27B 33/10

(52) U.S. Cl. 83/697; 30/356

(57) ABSTRACT

A saw blade is used on an electric power saw designed to reciprocate the saw blade. The saw blade has a plurality of saw teeth, a first line extending along tips of the saw teeth, a second line that extends straight between one tip of a distal endmost saw tooth and another tip of a proximal endmost saw tooth. The first line is curved toward roots of the saw teeth with respect to the second line. The second line ranges from 100 to 400 mm in length. One of tips of the saw teeth at a maximum distance from the second line is spaced apart from the second line by a distance of not more than 12 mm.

### BACKGROUND OF THE INVENTION

Present invention relates to a saw blade for an electric power saw designed to reciprocate said saw blade.

An electric power saw such as an electric power saber saw has a saw blade reciprocated for cutting a workpiece. Conventionally, a saw blade for use on such an electric power saw has a substantially straight line extending along tips of saw teeth. In addition, saw blades having a non-straight or curvilinear line extending along the tips due to some causes arising in the manufacturing process thereof are heretofore discarded as rejected objects.

However, the present inventors have discovered a fact as a result of a series of experiments, studies, and trial-and-error procedures. More specifically, when a line extending along tips of saw teeth is curved to a certain degree toward roots of the teeth with reference to a straight line that extends between one tip of a distal endmost saw tooth and another tip of a proximal endmost saw tooth, the saw blade for the electric power saw designed to reciprocate the saw blade provides better blade sharpness or cutting performance and durability.

Therefore, an object of the present invention is to provide improvements in the cutting performance and durability of a saw blade for electric power saw according to such knowledge.

### SUMMARY OF THE INVENTION

In view of the above, the present invention provides a saw blade for an electric power saw designed to reciprocate said saw blade comprising a plurality of saw teeth, a first line extending along tips of said saw teeth, and a second line that extends straight between one tip of a distal endmost saw tooth and another tip of a proximal endmost saw tooth wherein said first line is curved toward roots of said saw teeth with respect to said second line.

Specifically, the second straight line preferably ranges not less than 100 mm and not more than 400 mm in length. In addition, a tip at the maximum distance from the second straight line is preferably spaced apart from the second straight line by a distance of not more than 12 mm.

More specifically, the second straight line preferably ranges not less than 150 mm and not more than 300 mm in length. In addition, a tip at the maximum distance from the second straight line is preferably spaced apart from the second straight line by a distance of not more than 8.9 mm.

The saw blade according to the present invention, in which the first line extending along the tips of saw teeth is curved toward roots thereof, is advantageous in sharpness or cutting performance and durability over conventional motorized saw-adapted saw blades having a substantially straight line extending along the tips of saw teeth.

### BRIEF DESCRIPTION OF THE DRAWINGS

FIG. 1 is a front view illustrating a saw blade for an electric power saw according to an embodiment of the present invention;

FIG. 2 is a partial front view illustrating an example how the saw blade is curved;

FIG. 3 is a plan view of FIG. 2;

FIG. 4 is a schematic view showing a relationship between a saw blade for an electric power saw having a straight tip line and a pipe (at an initial cutting stage);

FIG. 5 is a schematic view showing a relationship between a saw blade for an electric power saw according to the present invention and the pipe (at an initial cutting stage);

FIG. 6 is a schematic view showing a relationship between the saw blade having the straight tip line and the pipe (in the process of cutting the pipe);

FIG. 7 is a schematic view showing a relationship between the saw blade according to the present invention and the pipe (in the process of cutting the pipe);

FIG. 8 is a schematic front view illustrating an experimental apparatus for the saw blade;

FIG. 9 is a graph illustrating an experimental result from experimental example 1;

FIG. 10 is a graph illustrating an experimental result from experimental example 2; and,

FIG. 11 is a graph illustrating an experimental result from experiment example 3.

### DETAILED DESCRIPTION OF THE PREFERRED EMBODIMENT

The present invention will now be described in detail in accordance with an embodiment illustrated in the drawings.

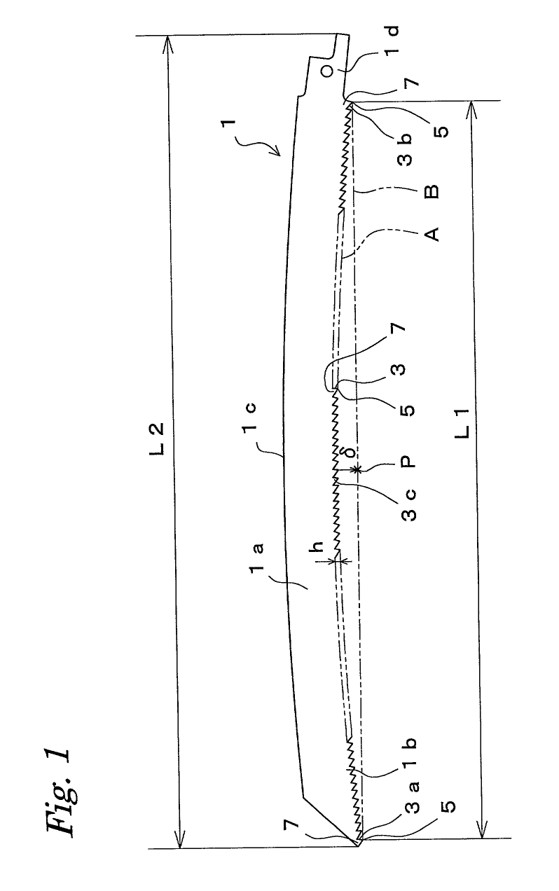

FIG. 1 illustrates a motorized saw-adapted saw blade 1 according to the embodiment.

The saw blade 1 is of an elongated blade type used on an electric power saber saw. A saw blade body 1a has a plurality of saw teeth 3 formed at one side portion 1b thereof at constant pitches. The saw teeth 3 have an invariable height “h”. The saw blade body 1a further has an attachment portion 1d provided at a proximal end thereof. The saw blade 1 is fitted to the saber saw at the attachment portion 1d.

A line (hereinafter refereed to “tip line”) “A” extending along tips 5 of the saw teeth 3 is curved toward roots 7 of the saw teeth 3 in a convex fashion with reference to a straight line (hereinafter refereed to “reference line”) “B” that extends between one tip 5 of a distal endmost saw tooth 3a and another tip 5 of a proximal endmost saw tooth 3b. To be specific, the tip line “A” is curved into a concave line segment relative to the reference line “B.” Pursuant to the present embodiment, the tip line “A” is curved at a substantially fixed curvature. A distance “δ” between the tip 5 and the reference line “B” is made greatest at a saw tooth 3c opposite to a central point “p” of the reference line “B.” The distance “δ” is made smaller in stages toward the distal and proximal endmost sides of the saw blade body 1a.

A sufficient degree to which the tip line “A” is curved to provide good cutting performance and durability depends on a length of the reference line “B” or a distance (actual blade length “L1”) between the opposite endmost saw teeth 3a and 3b. According to the experiments and studies conducted by the present inventors, the distance “δ” is preferably not more than 12 mm when the actual blade length L1 lies within the range of not less than 100 mm and not more than 400 mm. More specifically, the distance “δ” preferably falls within the range of not less than 0.4 mm and not more than 5.0 mm when the actual blade length L1 is not less than 100 mm and not less than 200 mm. The distance “δ” preferably lies between not less than 1.5 mm and not more than 9.0 mm when the actual blade length L1 is not less than 200 mm and not more than 300 mm. The distance “δ” preferably ranges from not less than 3.0 mm and not more than 12.0 mm when the actual blade length L1 is not less than 300 mm and not than 400 mm.

The saw blade 1 having the tip line “A” thus curved provides improved sharpness or cutting performance, and thus cuts a workpiece in reduced time, when compared with conventional electric power saw-adapted saw blades that include linearly aligned tooth tips. In addition, the saw blade 1 having such a curved tip line “A” provides improved durability, and is thus able to cut an increased number of workpieces during a period of time from bring the saw blade 1 into service to drawing the saw blade 1 from service at the end of lifetime thereof.

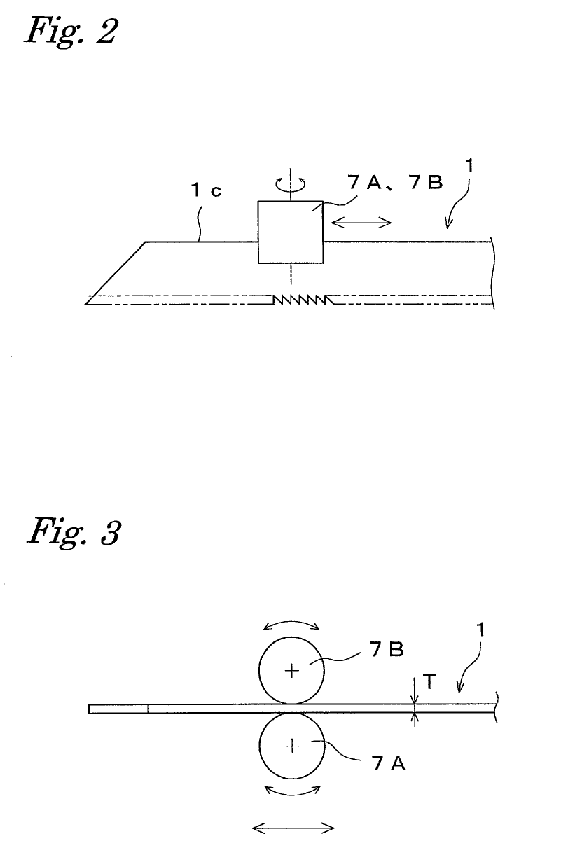

FIGS. 2 and 3 illustrate how the tip line “A” is curved toward the roots of the saw teeth 3, as described in the present embodiment. As shown in FIGS. 2 and 3, there are provided a pair of rollers 7A and 7B for sandwiching the saw blade body 1a at a side portion 1c opposite to the side portion 1b formed with the saw teeth 3 in a thickness direction of the saw blade 1. In order to curve the tip line “A”, the rotating rollers 7A and 7B are merely required to be moved in a longitudinal direction of the saw blade 1. The side portion 1c pressed by the rollers 7A and 7B is elongated in the longitudinal direction of the saw blade 1, thereby curving the opposite side portion 1b in which the saw teeth 3 are formed. However, such a method for curving the saw blade 1 is not limited to the above, but is susceptible to any alternative in which the saw blade 1 is curved within the above-described range.

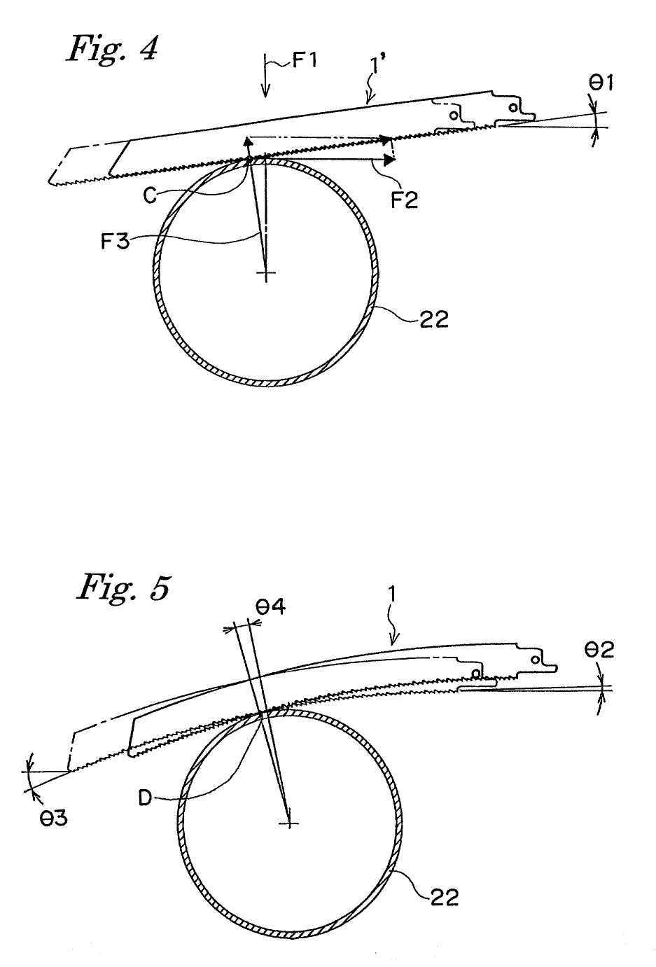

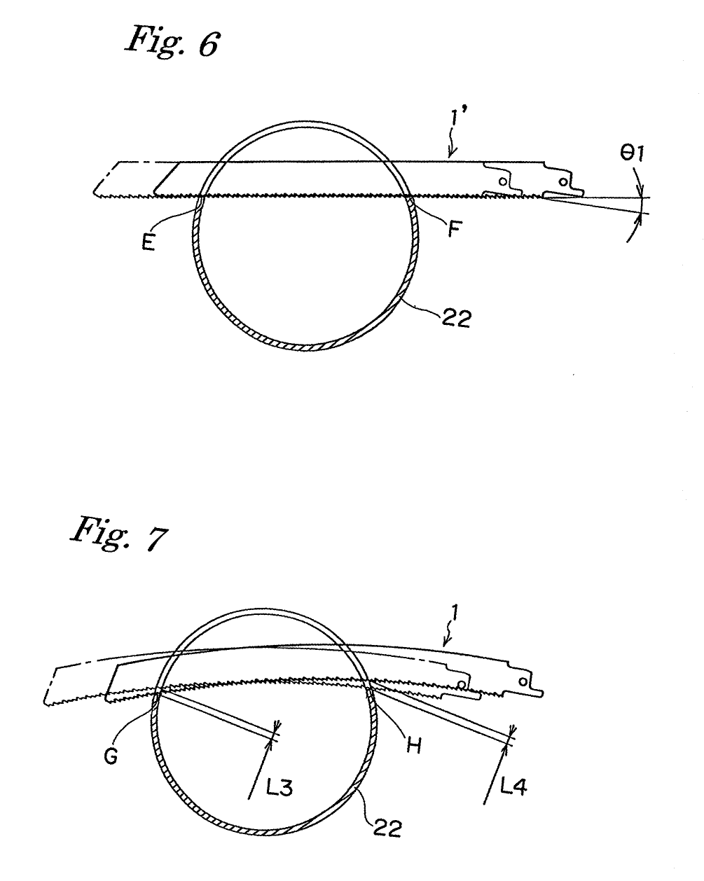

It is presumed that the saw blade 1 having such a curvilinear tip line “A” provides quicker cutting and improved durability because of the under-mentioned reasons. FIG. 4 illustrates a relationship between a prior art saw blade 1′ having a straight tip line “A” and a pipe 22 at an initial cutting stage when the pipe 22 is cut using the saw blade 1′. FIG. 5 illustrates a relationship between the saw blade 1 having the curvilinear tip line “A” according to the present embodiment and the pipe 22 at an initial cutting stage when the pipe 22 is cut using the saw blade 1. FIG. 6 illustrates a relationship between the prior art saw blade 1′ and the pipe 22 when the pipe 22 is cut to a certain degree. FIG. 7 illustrates a relationship between the saw blade 1 according to the present embodiment and the pipe 22 when the pipe 22 is cut to a certain degree.

As illustrated in FIG. 4, in order to cut the workpiece in less time using the reciprocating saw blade 1′, usual practice is to form the tip line “A” at an angle (hereinafter referred to as “tip angle”) θ1 with respect to a reciprocating direction of the saw blade 1′. Then, an operator pushes the saw blade 1′ into the pipe 22, thereby generating an engaging force F1. The engaging force F1 and component F3 perpendicular to the tip line “A” of saw blade-pulling force, thereby resulting in overall engaging forces of the saw teeth 3 to the pipe 22 (See FIG. 1). On the other hand, saw blade durability is determined by tip hardness and cutting heat generated between a material to be cut and the tips of the saw teeth. In other wards, when a viscous material such as stainless steel, which is difficult to cut, is cut using the saw blade 1′, then the cutting heat particularly tends to be elevated. Such elevated cutting heat anneals the tips, and thus reduces the tip hardness. As a result, the service life of the tips decreases.

In the prior art saw blade 1′ having the straight tip line “A” and the constant tip angle θ1 as illustrated in FIG. 4, the tip line “A” is formed at the tip angle θ1 in relation to the pipe 22, even when the saw blade 1′ is located at a frontmost position (the left in FIG. 4) in which the saw blade 1′ is pulled at a speed of zero. As a result, resistance to cutting is so large that the saw blade 1′ must be moved rearward with increased power. This means inconveniently increasing a speed at which the saw blade 1′ is moved. In addition, when cutting of the pipe 22 is started as shown in FIG. 4, the tip line “A” contacts an outer circumference of the pipe 22 at a substantially fixed cutting point “C.” As a result, the tips at the cutting point “C” tend to be high in temperature.

On the other hand, in the saw blade 1 according to the present invention, having the curvilinear tip line “A” as illustrated in FIG. 5, the tip angle is made greater in stages toward a distal endmost portion of the saw blade 1 from a proximal endmost portion thereof, as illustrated as θ2 and θ3 in FIG. 5. As a result, when the saw blade 1 is located at a frontmost position in which the saw blade 1 is pulled at a speed of zero, the tip angle (or a tangential angel defined between the curved tip line “A” and the pipe 22) can be made small. Therefor, only a small amount of power is required to move the saw blade 1 rearward. This allows for a smooth rise in a speed at which the saw blade 1 is moved. Furthermore, since such a smoothly increased speed can be imparted to the saw blade 1, the tip angle can be made greater than that in the conventional saw blade 1′ when the saw blade 1 is located at a rearmost position (the right side in FIG. 5). As a result, the pipe 22 can be cut in shorter time. Moreover, as seen from FIG. 5 in which the initial cutting stage is shown, the curvilinear tip line “A” causes a position “D”, at which the pipe 22 contacts the tip line “A”, to be moved within a range of an angle θ4. As a result, the temperature of the tips at the cutting point is distributed, and is thereby maintained lower than that in the conventional saw blade 1′. Consequently, the saw blade 1 provides improved durability.

As evident from FIG. 6, the conventional saw blade 1′ having the straight tip line “A” always cuts the pipe 22 at two cutting points “E” and “F” in the process of cutting the pipe 22. The center of the pipe 22 is positioned between the cutting points “E” and “F.” Since the tips 5 are in constant contact with the pipe 22 at the two cutting points “E” and “F”, the saw blade 1′ is not cooled and tends to rise in temperature at these two cutting points “E” and “F.”

On the other hand, as seen from FIG. 7, in the saw blade 1 having the curvilinear tip line “A” according to the present invention, cutting points “G” and “H” are moved upward and downward by distances “L3” and “L4”, respectively, depending upon where the saw blade 1 is positioned. This means that the pipe 22 is alternately cut at the cutting points “G” and “H” while the saw blade 1 is caused to travel through a travel stroke thereof. As a result, the tips 5 are cooled at the cutting point “G” or “H” where no cuts are made to the pipe 22 at definite time intervals. Accordingly, the temperature of the tips 5 remains lower than that in the conventional saw blade 1′, with the result that the saw blade 1 provides improved durability.

### EXPERIMENTAL EXAMPLES

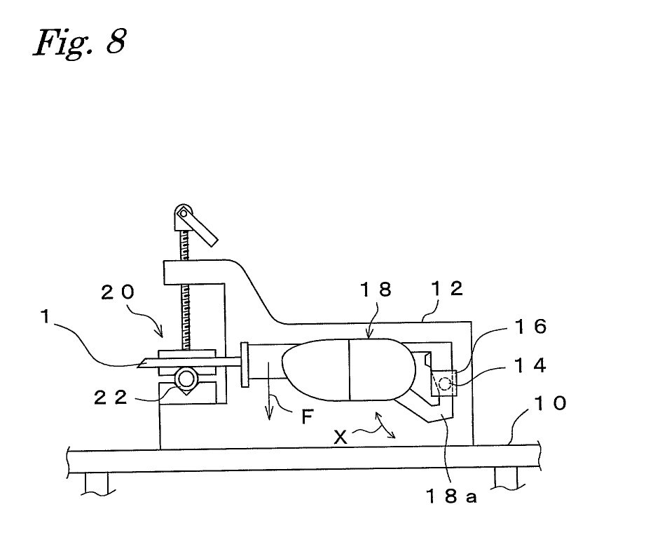

In order to assure that the electric power saw-adapted saw blade according to the present invention provides better cutting performance and durability than those of the conventional saw blade having the straight tip line, experiments were made using an experimental apparatus as illustrated in FIG. 8.

The experimental apparatus is provided with a frame 12 disposed on a table 10. Attached to the frame 12 is a horizontally extending support shaft 14. A proximal end of the support shaft 14 is fixed to the frame 12 at one end thereof (the right in FIG. 8). A setting member 16 is rotatably mounted on the support shaft 14 at a distal end thereof. An electric power saber saw 18 (model No. CR10V, produced by Hitachi Koki Co., Ltd.) has a handle 18a rigidly secured to the setting member 16. The saber saw 18 having a saw blade 1 attached thereto are thereby pivotable about the support shaft 14 as shown by an arrow “X” in FIG. 8. The frame 12 further has a thread-type fastening clamp mechanism 20 provided at the other end thereof (the left in FIG. 8). The clamp mechanism 20 retains one end of a workpiece or pipe 22. The saber saw 18 has a deadweight (not shown) secured to a distal end thereof. By this deadweight, a downward load “F” acts to the saber saw 18.

### Experimental Example 1

In experimental example 1, there were provided six different saw blades 1 having the respective tip lines “A” curved to various levels. Namely, these saw blades 1 had the tip lines “A” spaced apart from the reference lines “B” at the respective centers thereof by distances “δ” of 0.0 mm, 0.5 mm, 0.7 mm, 1.2 mm, 1.6 mm, and 2.0 mm. On the other hand, all these saw blades 1 were made of SKH51, and had a full length “L2” of 150 mm (an actual blade length “L1” of 129 mm), a blade width “W” of 18 mm, a thickness “T” (see FIG. 3) of 0.9 mm. Further, in all these saw blades 1, the saw teeth 3 were formed at a pitch of 14 pieces per inch. The pipe 22 used in this example were made of SUS304, and had a diameter of 21 mm and a thickness of 2.8 mm. The load “F” was set to be 2.0 kg.

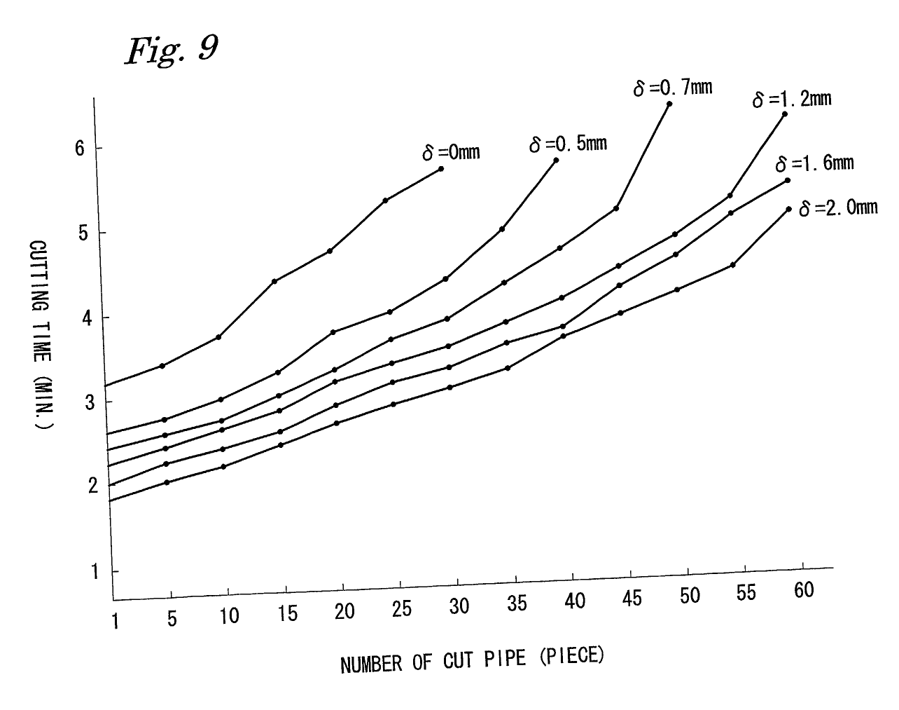

Under these conditions, the pipes 22 were cut using the above experimental apparatus until cutting becomes impossible. The time required for completely cutting the pipes 22 (cutting time) was measured for each time when a total of five pieces were cut. FIG. 9 illustrates experimental results from the present example 1.

### Experimental Example 2

In experimental example 2, the cutting time was measured using seven different saw blades 1 having the tip lines “A” differently curved (and further having the tip lines “A” spaced apart from the reference lines “B” at the respective centers thereof by distances “δ” of 0.0 mm, 1.5 mm, 2.0 mm, 2.5 mm, 3.0 mm, 3.5 mm, and 4.3 mm). On the other hand, all these saw blades were SKH51 and had a full length “L2” of 195 mm (actual blade length “L1” of 174 mm), a blade width “W” of 18 mm, and a thickness “T” of 0.9 mm. Further, in all these saw blades 1, the saw teeth 3 were formed at a pitch of 14 pieces per inch.

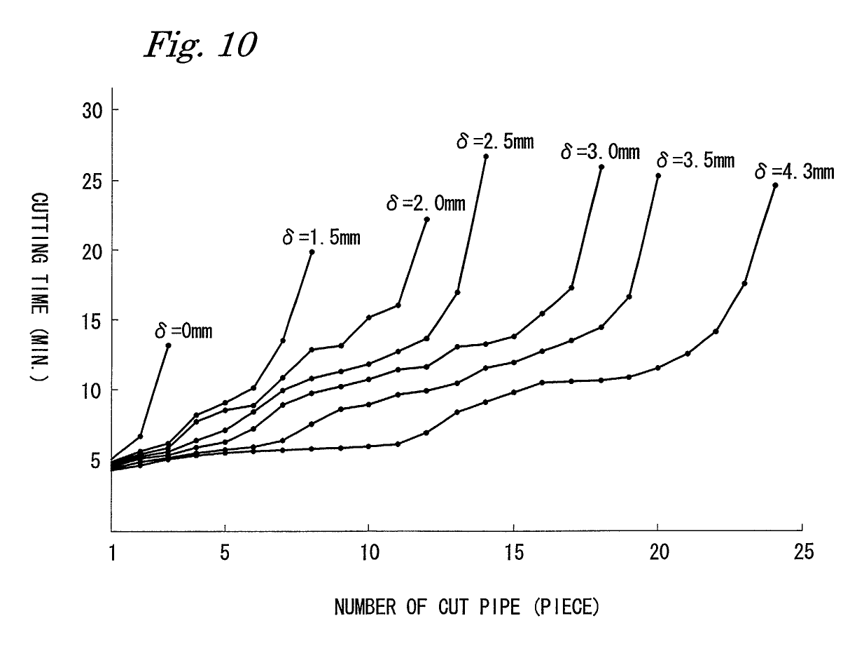

The pipe 22 used in this example were made of SUS304, and had a diameter of 60.5 mm and a thickness of 2.0 mm. The load “F” was set to be 2.5 kg. FIG. 10 illustrates experimental results from the present example 2.

### Experimental Example 3

In experimental example 3, the cutting time was measured using seven different saw blades 1 having the tip lines “A” curved to different degrees (and further having the tip lines “A” spaced apart from the reference lines “B” at the respective centers thereof by distances δ of 0.0 mm, 2.0 mm, 3.2 mm, 4.1 mm, 4.5 mm, 6.2 mm, and 8.9 mm).

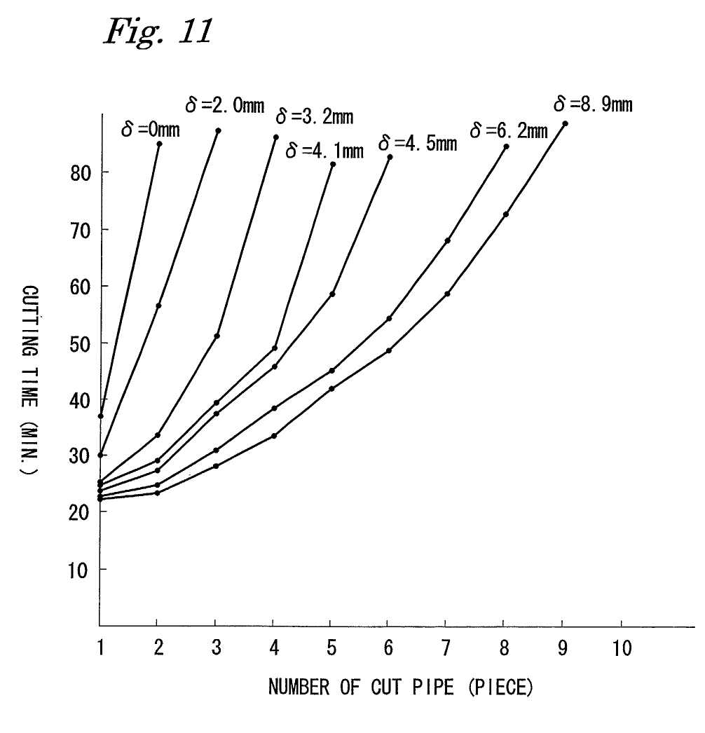

On the other hand, all these saw blades 1 were made of SKH51, and had a full length “L2” of 300 mm (an actual blade length “L1” of 279 mm), a blade width “W” of 18 mm, a thickness “T” of 0.9 mm. Further, in all these saw blades 1, the saw teeth 3 were formed at a pitch of 14 pieces per inch. The pipe 22 used in this example were made of SUS304, and had a diameter of 114.3 mm and a thickness of 3.0 mm. The load “F” was set to be 3.0 kg. FIG. 11 illustrates experimental results from the present example 3.

It is assured from FIGS. 9 to 11 that the saw blade 1 having the tip line “A” curved toward the roots of the saw teeth 3 provides a reduction in the cutting time and an increased number of pipes 22 that can be cut, when compared with the saw blade 1′ having the linearly aligned tips 5 (δ=0.0 mm). In experimental examples 1, 2 and 3, metal pipes 22 were used as workpieces. Alternatively, when a resin or wooden pipe, a metal, resin, or wooden solid bar member, and a metal, resin, or wooden plate member are used as workpieces, then the saw blade 1 having the tip line “A” curved to the aforesaid extent provides improved cutting performance and durability as well.

In the above-described embodiment, each saw tooth has a constant height. Alternatively, the present invention is evidently applicable to a saw blade having two or more different teeth aligned with each other in predetermined order, which teeth have different heights. In this case, such a saw blade obviously has two or more tip lines “A” curved relative to the reference line “B.” In addition, although the saw blade 1 has the saw teeth 3 formed at a constant pitch in the embodiment, present invention is, of course, applicable to another saw blade having the saw teeth 3 defined at irregular pitches.

Further, although the electric power saw-adapted saw blade according to the above embodiment is used on an electric power saber saw that is manually handled by an operator, the saw blade according to the present invention is further usable on a portable jigsaw, or alternatively on an electric power saw that is disposed on a table or platform.

When the actual blade length falls within the aforesaid range, and further when either a singular or plural tip lines “A” are curved according to the preceding range, then the electric power saw-adapted saw blade according to the present invention is not restricted in other size and shape such as the full length, the width, the thickness, and the tooth pitch.

As evidenced by the above description, in the saw blade for the electric power saw designed to reciprocate said saw blade, the line extending along the tips of the saw teeth is curved toward the roots thereof relative to the straight line that extends between one tip of the distal endmost saw tooth and another tip of the proximal endmost saw tooth. The saw blade having such a curvilinear tip line is advantageous in sharpness or cutting performance and durability over conventional electric power saw-adapted saw blades having a substantially straight tip line.

Although the present invention has been fully described by way of the examples with reference to the accompanying drawings, it is to be noted here that various changes and modifications will be apparent to those who skilled in the art. Therefore, unless such changes and modifications otherwise depart from the spirit and scope of the present invention, they should be construed as being therein.

What is claimed is:

1. A saw blade for an electric power saw designed to reciprocate said saw blade comprising:
a plurality of saw teeth,
a first line extending along tips of said saw teeth, and
a second line that extends straight between one tip of a distal endmost saw tooth and another tip of a proximal endmost saw tooth
wherein said first line is curved toward roots of said saw teeth with respect to said second line.

2. A saw blade for an electric power saw designed to reciprocate said saw blade comprising:
a plurality of saw teeth,
a first line extending along tips of said saw teeth, and
a second line that extends straight between one tip of a distal endmost saw tooth and another tip of a proximal endmost saw tooth
wherein said first line is curved toward roots of said saw teeth with respect to said second line,
wherein said second line ranges not less than 100 mm and not more than 400 mm in length, and
wherein one of tips of said saw teeth at a maximum distance from said second line is spaced apart from said second line by a distance of not more than 12 mm.

3. A saw blade for an electric power saw designed to reciprocate said saw blade comprising:
a plurality of saw teeth,
a first line extending along tips of said saw teeth, and
a second line that extends straight between one tip of a distal endmost saw tooth and another tip of a proximal endmost saw tooth
wherein said first line is curved toward roots of said saw teeth with respect to said second line,
wherein said second line ranges not less than 150 mm and not more than 300 mm in length, and
wherein one of tips of said saw teeth at a maximum distance from said second line is spaced apart from said second line by a distance of not more than 8.9 mm.
